(19) United States
(12) Patent Application Publication
(10) Pub. No.: US 2003/0030550 A1
(43) Pub. Date: Feb. 13, 2003

(54) Child safety device for buses

(76) Inventor: Douglas C. Talbot, Eagle Vail, CO (US)

Correspondence Address: NIXON & VANDERHYE P.C., 8th Floor, 1100 North Glebe Road, Arlington, VA, 22201, US

(21) Appl. No.: 09/877,393

(22) Filed: Jun. 8, 2001

(51) Int. Cl. B60Q 1/26

(52) U.S. Cl. 340/433; 340/457; 340/539

(57) ABSTRACT

A bus safety system for reminding a driver to search a bus for passengers comprising a receiver module incorporating a microprocessor, the receiver module programmed to control an alarm based on at least one selected time interval following activation; a wire harness attachable between the receiver module and an electrical system of the bus; and a transmitter incorporating an alarm deactivation switch and adapted to send RF signals; wherein the receiver module is adapted to receive the RF signals from the transmitter.

This invention relates to a safety device for buses, and specifically, to a child safety device particularly applicable to school buses.

### BACKGROUND OF THE INVENTION

There are several alarm systems currently available for ensuring that no children are left on a bus after the last scheduled stop. These systems require the driver to walk to the back of the bus to deactivate an alarm that will otherwise sound after a predetermined interval. In some cases, the driver can perform the check and deactivate the alarm while the ignition is on, for example, after the last stop but before returning to the bus yard. Examples of such alarm systems may be found in U.S. Pat. Nos. 6,107,915; 5,874,891; 5,243,323 and 5,128,651.

In each case, the alarm system is connected to the existing electrical system in the bus, and alarm components at the front and rear of the bus are hard wired. There remains a need for a safety alarm system that is simpler and less costly to install, and that provides bus drivers with greater flexibility with respect to the use and operation of the alarm system, but which does not permit the system to be circumvented.

### BRIEF SUMMARY OF THE INVENTION

This invention provides a microprocessor-controlled wireless system for ensuring that the bus driver checks the bus for children after the last stop, and after the ignition has been turned off. This system includes a self-contained battery operated transmitter located at the rear of the bus, and a self-contained receiver module located at the front of the bus. Utilization of radio frequency (RF) signals eliminates the need for hard wiring between the receiver module and the transmitter.

The receiver module at the front of the bus includes a microprocessor and a “plug-in” wire harness that is easily connected to the bus electrical system. In its simplest form, the receiver module need be connected only to the bus battery positive cable or terminal, the chassis ground, and the ignition “on” switch positive wire. Built-in circuitry is provided, however, for pre-alarm warning, pre-alarm and full alarm features, that may include the bus horn, parking lights, optional siren or any combination thereof. An optional plug-in LED provides visual indication of the alarm status. Momentary and service related override switches may also be included.

The battery operated transmitter located at the rear of the bus includes a deactivation button and a 9-volt battery compartment, but the transmitter could also be powered by the bus battery.

In an exemplary configuration, when the driver turns the ignition off, the receiver module is programmed to beep intermittently for a predetermined time period (a pre-alarm warning). Thus, the driver has a relatively short but sufficient time to inspect the bus. During this initial time period, the transmitter is active but ignored by the receiver, so that it will not stop the further alarm sequence even if the deactivation button is pushed, i.e., the full initial time period must expire before the alarm deactivation button on the transmitter is effective.

After the first or initial time period, the intermittent beeping in the receiver module becomes a continuous beep (i.e., a pre-alarm) to remind the driver that he/she has an additional period of time (preferably shorter than the first period) to finish checking the bus and to press the deactivation button on the transmitter to thereby preclude a full alarm from sounding. The full alarm will sound after these two time intervals (from ignition shut-off) if not deactivated.

The receiver module also includes two built-in relays that both begin to cycle after the second time period expires. One stops the horn sound after, for example, 3 minutes in the full alarm state, while the other continues the full alarm indefinitely, with the additional alarm elements, i.e., lights and/or siren.

The system may be deactivated at any time by turning the ignition key to the ignition “on” position, or the ignition “accessory” position; by using the optional momentary override switch; or by pressing the transmitter deactivation button after the initial pre-alarm warning. Additional installation details are provided further herein.

The invention described herein is not limited to wireless RF arrangements. The programmable receiver module and the specific pre-alarm and alarm sequences may be implemented with other systems including, for example, infrared, acoustic and hard wired.

Accordingly, in one aspect, the invention relates to a bus safety system for reminding a driver to search a bus for passengers comprising a receiver module incorporating a microprocessor, the receiver module programmed to control an alarm based on at least one selected time interval following activation; a wire harness attachable between the receiver module and an electrical system of the bus; and a transmitter incorporating an alarm deactivation switch and adapted to send RF signals; wherein the receiver module is adapted to receive the RF signals from the transmitter.

In another aspect, the invention relates to a bus safety system for reminding a driver to search the bus for passengers comprising a receiver module incorporating a microprocessor and programmed to control an alarm sequence based on selected time intervals following activation and a wire harness attachable between the receiver module and an electrical system of the bus; and a transmitter incorporating an alarm deactivation switch and adapted to transmit RF signals to the receiver module; and at least one override switch electrically connected to an ignition switch accessory position for deactivating the system.

In still another aspect, the invention relates to a bus safety system for reminding a driver to search a bus for passengers comprising a receiver module incorporating a means for controlling an alarm based on at least one selected time interval following activation; a wire harness attachable between the receiver module and an electrical system of the bus; and a transmitter incorporating an alarm deactivation switch; wherein at least one selected time interval provides sufficient time for the driver to search the bus for passengers, after which said means activates an alarm sequence.

In still another aspect, the invention relates to a bus comprising a chassis; an electrical system including a horn and parking lights, and an ignition switch including accessory and on positions, a safety system for reminding a driver to search a bus for passengers comprising a receiver module incorporating a microprocessor, the receiver module programmed to control an alarm based on at least one selected time interval following activation; a wire harness attachable between the receiver module and the electrical system of the bus; and a transmitter incorporating an alarm deactivation switch and adapted to send RF signals to the receiver module.

Objects and advantages not expressly mentioned above will become apparent from the detailed description that follows.

### BRIEF DESCRIPTION OF THE DRAWINGS

FIG. 1 is a simplified perspective of a bus chassis, indicating the location of the wireless RF components of the invention; and

FIG. 2 is a simplified wiring diagram, illustrating the receiver module wiring harness connections to the bus electrical system.

### DETAILED DESCRIPTION OF THE INVENTION

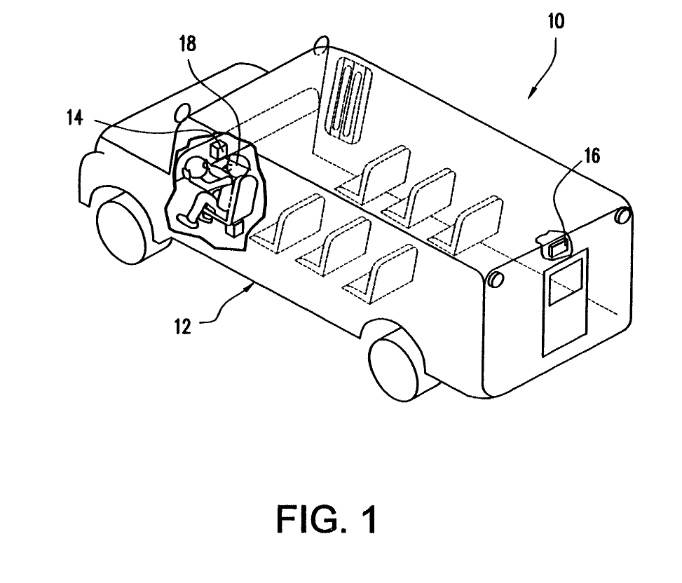

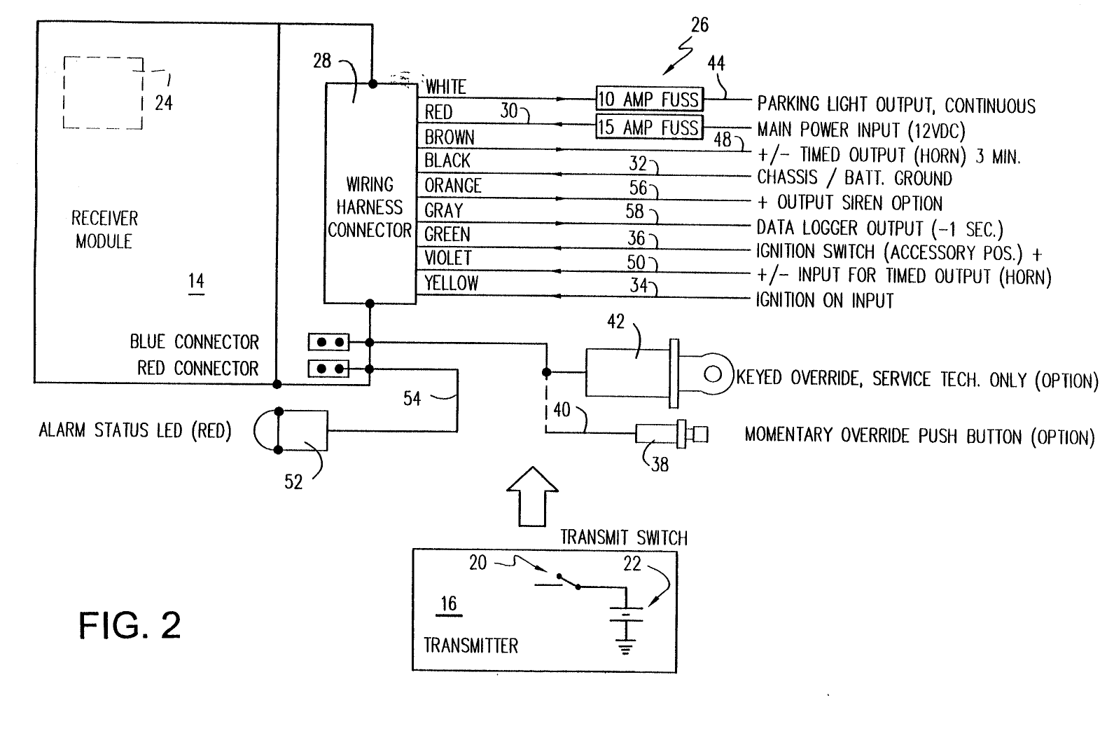

With reference to FIGS. 1 and 2, a typical bus 10 includes a chassis generally indicated at 12. A receiver module 14 in accordance with the invention is shown at the forward end of the chassis, in proximity to the bus driver 18, e.g., on the dashboard. A transmitter 16 is located at the rear of the bus, preferably in an out-of-the-way position, relatively inaccessible to passengers in the bus. The receiver module 14 is intended to work with the existing wiring of the bus, and to receive wireless radio frequency (RF) signals from the transmitter 16. Thus, no hard wiring is required between the receiver/controller and the transmitter.

The transmitter 16 is a self-contained battery operated transmitter with a single one-button transmitter switch 20 (representing the deactivation button). The transmitter is powered by a single nine volt battery 22 with an approximate three year life, but the battery is located in an easily accessible compartment for replacement. Alternatively, the transmitter may be powered by the bus battery.

As indicated above, the transmitter 16 is preferably mounted inside the bus at the rear end thereof, in an up and out of the way location so as not to invite access by bus passengers. The transmitter may be attached by one or more screws (or other suitable fasteners) to a desired mounting location, and preferably incorporates a cover that permits access to the battery compartment.

The receiver module 14 is located at the driver end of the bus, preferably on or under the dashboard, keeping in mind the need to make a connection to the ignition switch, power supply and relay control panel already existing in the bus.

The receiver module 14 is also preferably mounted using one or more screws or other suitable fasteners. It is important that the antenna wire (not shown) of the receiver module 14 not be covered by any metal bus chassis parts so as not to impede its range.

The receiver module 14 incorporates a microprocessor 24 (or equivalent circuitry) programmed to sequence the alarm conditions as further described herein. A main wiring harness 26, with a plug-in connector 28 adapted for connection with the receiver module, enables a series of electrical inputs to, and outputs from, the receiver module 14, and is used to connect the receiver module to the bus electrical system without modification of the latter. On the input side, wire 30 is connected to the twelve volt bus battery and wire 32 is connected to a chassis ground. Wire 34 is connected to the main ignition switch wire, while wire 36 is connected to the ignition switch “accessory” position wire. An optional momentary override switch 38 may be mounted at a location (remote or proximate to the receiver module), for programming and emergency override situations. The override switch 38 is connected to the receiver module via wire 40. A keyed override switch 42 may be in a hidden location, available for service technicians only.

On the output side, wire 44 is connected to the buses' flashing parking lights 46 (see FIG. 1), and wire 48 is connected to the horn. Relays in the receiver module 14 are programmed to limit the horn sounds in full alarm to 3 minutes as described further below. An input wire 50 for the timed output is also connected to the horn. An alarm status indicator (an LED device) 52 is connected to the receiver module via wire 54 and an optional siren is connected via wire 56. An optional data logger for monitoring system activity may be connected to the receiver module via harness wire 58. It will be appreciated that the described harness 26 is exemplary only, and other harness configurations may be provided, depending on the particular application.

Operation of the wireless safety system in a preferred but exemplary configuration is as follows. Once the bus driver ends his/her run, and the ignition switch is turned “off,” a microprocessor-controlled beeping sound of 90 second duration prompts the driver to check for children remaining in the bus. Thus, the driver will have 90 seconds to check around and under each seat, as he progresses to the rear of the bus. During this initial 90 seconds of pre-alarm warning, the deactivation button on the transmitter 16 (for closing the switch 20) mounted at the back of the bus remains active but the receiver is programmed to ignore the transmitter during the 90 second pre-alarm warning. Therefore, the pre-alarm warning must expire before the transmitter 16 is recognized. After 90 seconds, the intermittent beeping is programmed to become continuous, so as to remind the driver that he or she has an additional 30 seconds to finish checking the bus and to press the deactivation button on the transmitter 16 to close the switch 20 and prevent the full alarm from sounding. This additional 30 seconds is also referred to as the pre-alarm stage. The specific time durations mentioned herein are exemplary only, and the receiver module may be programmed for different time periods as desired.

The full alarm will sound after two minutes (the 90 second pre-alarm warning and 30 second pre-alarm) if the transmitter button is not pushed. The full alarm may consist of flashing of the parking lights 46, intermittent sounding of the horn 50, and/or the optional siren 58 in any combination. Horn sounds in the full alarm state are controlled by a relay (not shown) in the receiver and limited to three minutes if not deactivated. However, a second relay (not shown) may continue the full alarm with flashing parking lights (with or without siren). The duration of the various sounds and/or lights in the full alarm state can be programmed as desired, and are oftentimes dictated by local ordinances.

The alarm system may be deactivated at any time by turning the ignition switch 36 to the “on” or “accessory” position, or activating the override switch 36, or by pushing the transmitter button after the 90 second pre-alarm has expired.

The inclusion of parking lights 46 in the alarm is especially helpful, particularly in instances where there are numerous school buses parked in a lot, and in the full alarm state, the school bus can be easily detected via the flashing lights, enabling the alarm to be turned off more quickly. In addition, using the optional override switch 38 prevents the alarm system from sounding on a momentary or temporary basis, while the keyed override switch 42 is available for service requirements by technicians. Upon completion of any maintenance, the system must be activated and a 90 second wait completed before activating the system in a normal manner.

The mounting override switch 38 is designed to connect to the ignition switch “accessory” position, dome light or door switch. Thus, the override switch will disarm all alarm conditions while picking up children, or in stop and go situations when the engine must be turned off. For example, local requirements may dictate maximum engine idle time, after which the engine must be turned off.

The receiver module 14 utilizes ultra low idle current when the ignition is “off” and the alarm deactivated. Thus, there is no significant drain on the vehicle battery 24 when the system is inactive. In addition, the receiver module 14 and transmitter 16 are individually coded to prevent bus-to-bus interference and the receiver can learn new transmitter codes. This allows either of the transmitter or receiver module to be replaced individually in the case of failure.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A bus safety system for reminding a driver to search a bus for passengers comprising:
a receiver module incorporating a microprocessor, said receiver module programmed to control an alarm based on at least one selected time interval following activation;
a wire harness attachable between the receiver module and an electrical system of the bus; and
a transmitter incorporating an alarm deactivation switch and adapted to send RF signals;
wherein said receiver module is adapted to receive said RF signals from the transmitter.

2. The system of claim 1 wherein said alarm comprises a sequence that includes a pre-alarm warning sound of a first duration followed by a different pre-alarm sound of a second duration shorter than said first duration.

3. The system of claim 2 and further comprising means for initiating a full alarm in the event the alarm deactivation switch is not pressed after said pre-alarm warning and before said pre-alarm sound terminates.

4. The system of claim 3 wherein said wire harness is adapted for electrical connection between the receiver module and the bus horn and bus parking lights, and wherein said full alarm includes at least horn sounds and flashing parking lights.

5. The system of claim 3 and further comprising an optional override switch for deactivating the system.

6. The system of claim 4 including a siren connected via the wire harness to the receiver module, to sound in said full alarm.

7. The system of claim 1 wherein said transmitter is battery operated.

8. The system of claim 1 wherein said wiring harness includes an alarm status indicator.

9. The system of claim 1 wherein said wiring harness includes a data logger for monitoring system activity.

10. A bus safety system for reminding a driver to search the bus for passengers comprising:
a receiver module incorporating a microprocessor and programmed to control an alarm sequence based on selected time intervals following activation and a wire harness attachable between the receiver module and an electrical system of the bus; and
a transmitter incorporating an alarm deactivation switch and adapted to transmit RF signals to said receiver module; and
at least one override switch electrically connected to an ignition switch accessory position for deactivating the system.

11. The system of claim 10 wherein said wire harness is adapted for electrical connection between the receiver module and the bus horn and bus parking lights, and wherein said full alarm includes horn sounds and flashing parking lights.

12. The system of claim 11 wherein said wire harness is also adapted for connection to a bus siren for sounding in said full alarm.

13. The system of claim 11 wherein said alarm sequence includes a pre-alarm warning sound of a first duration, and a pre-alarm sound of a second duration shorter than said first duration.

14. The system of claim 13 wherein said first duration is 90 seconds and said second duration is 30 seconds.

15. A bus safety system for reminding a driver to search a bus for passengers comprising:
a receiver module incorporating means for controlling an alarm based on at least one selected time interval following activation;
a wire harness attachable between the receiver module and an electrical system of the bus; and
a transmitter incorporating an alarm deactivation switch;
wherein said at least one selected time interval provides sufficient time for the driver to search the bus for passengers, after which the said means activates an alarm sequence.

16. The system of claim 1 wherein said at least one selected time interval has a duration of about 90 seconds and includes a pre-alarm warning sound.

17. The system of claim 16 wherein said alarm sequence includes a different pre-alarm sound for a second time interval shorter than said at least one selected time interval, followed by a full alarm.

18. The system of claim 17 wherein said second time interval is about 30 seconds.

19. The system of claim 17 wherein the receiver module is adapted for electrical connection to a horn and parking lights on the bus and wherein said full alarm includes components comprising at least horn sounds and flashing parking lights.

20. The system of claim 17 wherein said full alarm is activated for a third time interval of about 3 minutes for a selected one of said components of said full alarm, and indefinitely for at least another of said components of said full alarm unless otherwise deactivated.

21. The system of claim 15 and further comprising at least one override switch for deactivating the system.

22. The system of claim 20 including a siren connected via the wire harness to the receiver module, to sound in said full alarm.

23. The system of claim 15 wherein said means is configured to ignore any signal from said transmitter switch during said at least one selected time interval, and to deactivate the system when a signal is received from said transmitter after said at least one selected time interval.

24. In a bus comprising a chassis; an electrical system including a horn and parking lights, and an ignition switch including accessory and on positions, a safety system for reminding a driver to search a bus for passengers comprising:
a receiver module incorporating a microprocessor, said receiver module programmed to control an alarm;
a wire harness attachable between the receiver module and the electrical system of the bus; and
a transmitter incorporating an alarm deactivation switch and adapted to send RF signals to said receiver module to deactivate said alarm.
